(19) United States
(12) Patent Application Publication
(10) Pub. No.: US 2005/0278157 A1
(43) Pub. Date: Dec. 15, 2005

(54) System and method for simulating human movement using profile paths

(75) Inventor: Ulrich Raschke, Ann Arbor, MI (US)

Correspondence Address: BAKER BOTTS L.L.P., 2001 ROSS AVENUE, 6TH FLOOR, DALLAS, TX, 75201, US

(73) Assignees: Electronic Data Systems Corporation; Electronic Data Systems Corporation to UGS Corporation

(21) Appl. No.: 10/869,462

(22) Filed: Jun. 15, 2004

(51) Int. Cl. G06G 7/48

(52) U.S. Cl. 703/6

(57) ABSTRACT

According to one embodiment of the invention, a computerized method for simulating movement of a living object includes storing a plurality of sets of data, in which each set of data is indicative of an empirical path of a first segment of a first living object, receiving a start point and an end point for a desired movement of a second segment of a second living object, comparing the desired movement of the second segment to the stored sets of data, selecting, based on the comparison, a stored set of data that is representative of the desired movement of the second segment, and simulating the desired movement of the second segment based on the start point, the end point, and the empirical path associated with the selected set of data.

### TECHNICAL FIELD OF THE INVENTION

The present invention relates generally to the computer-aided design (“CAD”) industry and, more particularly, to a system and method for simulating human movement using profile paths.

### BACKGROUND OF THE INVENTION

Human movement simulation tools are used for ergonomic analysis of workplaces, products, training and service operations, as well as in the entertainment, industry. The process of accurately representing human movement is tedious, time-consuming, and requires skilled operators adept at manipulating complex 3D kinematic systems at the joint level. Efforts to model human movement using empirical observation of actual people performing tasks is referred to as motion capture technology. Subsequent statistical modeling of these movement data are limited by the form of the data. Both joint angle data over time and landmark data over time datasets are available. However, joint angle data may not be applied to arbitrary skeletal configurations because the angle definitions are dependent on the skeletal configuration. Landmark data require constraint solutions, in which the kinematic human “skeleton” is best fit to the landmark data using mathematical optimization methods, which are slow and inconsistent.

Another limitation of the current approach is that these empirical data tend to reflect the experimental conditions under which they were experimentally observed in the lab. For example, always beginning a movement from a “neutral starting posture.” In most simulations, however, the ending posture of the previous motion defines the starting posture of the next, so movements from arbitrary start postures are required. Collecting data and developing empirical models for the almost infinite number of tasks and loading conditions of which humans are capable are remote.

Another human movement modeling method utilizes key frame locations, such as in the robotics field. In this method, simple posture transition interpolators drive all joints such that they start moving and end at the same time. This results in a robotic looking motion, which looks unrealistic.

### SUMMARY OF THE INVENTION

According to one embodiment of the invention, a computerized method for simulating movement of a living object includes storing a plurality of sets of data, in which each set of data is indicative of an empirical path of a first segment of a first living object, receiving a start point and an end point for a desired movement of a second segment of a second living object, comparing the desired movement of the second segment to the stored sets of data, selecting, based on the comparison, a stored set of data that is representative of the desired movement of the second segment, and simulating the desired movement of the second segment based on the start point, the end point, and the empirical path associated with the selected set of data.

Embodiments of the invention provide a number of technical advantages. Embodiments of the invention may include all, some, or none of these advantages. In one embodiment, a human movement simulation method captures the complex choreography of human motion to realistically simulate human motion. Based on profile paths of particular segments of a skeletal configuration, simple posture transition methods may be modified to capture the complex choreography of the human motion. In this manner, the start points and end points from stored data sets are disassociated, which makes it easier to simulate human motion. This method may be adapted to any skeletal configuration in a consistent manner without having to utilize mathematical optimization methods. In addition, any reasonable kinematic skeletal configuration may be simulated, such as a human or other living object. The use of profile paths to simulate human movement may be adapted to the type of task (i.e., reach one-handed, reach two-handed, lifting, etc.) taking into account all parameters that may affect how humans move, including such factors as age, gender, and size. Embodiments of the present invention may help users that are unskilled in ergonomics and human factors science evaluate human factor concerns throughout all phases of a product engineering cycle.

Other technical advantages are readily apparent to one skilled in the art from the following figures, descriptions, and claims.

### BRIEF DESCRIPTION OF THE DRAWINGS

For a more complete understanding of the invention, and for further features and advantages, reference is now made to the following description, taken in conjunction with the accompanying drawings, in which:

FIG. 1A is a block diagram illustrating a human movement simulation system according to one embodiment of the invention;

FIG. 1B is a block diagram of a computer in the system of FIG. 1A for use in simulating human movement according to one embodiment of the invention;

FIG. 2 illustrates a simulation of a human placing a box on a shelf according to one embodiment of the present invention;

FIG. 3A is a profile path illustrating empirical data of the movement of the human's hand of FIG. 2 according to one embodiment of the invention;

FIG. 3B is a graph illustrating the distance along the x-axis of the human's hand with respect to time according to one embodiment of the invention;

FIG. 3C is a graph illustrating the distance along the y-axis of the human's hand with respect to time according to one embodiment of the invention;

FIG. 3D is a graph illustrating the orientation with respect to the x-axis of the human's hand with respect to time according to one embodiment of the invention; and

FIG. 4 is a flowchart illustrating a computerized method of simulating human movement according to one embodiment of the invention.

### DETAILED DESCRIPTION OF EXAMPLE EMBODIMENTS OF THE INVENTION

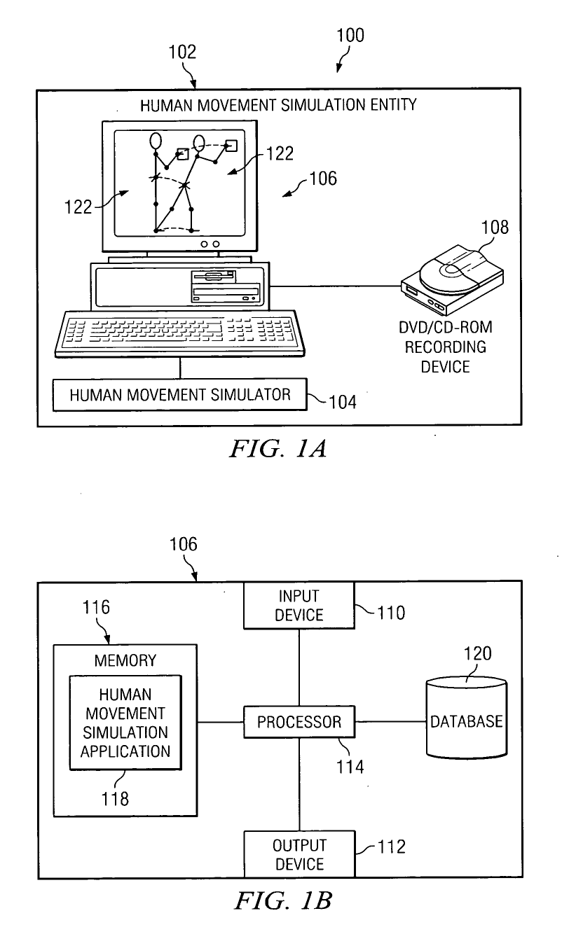

Example embodiments of the present invention and their advantages are best understood by referring now to FIGS. 1A through 4 of the drawings, in which like numerals refer to like parts.

FIG. 1A is a block diagram illustrating a human movement simulation system 100 according to one embodiment of the present invention. System 100 includes a human movement simulation entity 102 employing a human movement simulator 104 having access to a computer 106 and a recording device 108. Human movement simulation entity 102 may be any company or other suitable entity that desires to simulate human movement, such as with CAD/CAM/CAE software, animated movies, video games, and other suitable software applications. Human movement simulation entity 102 often has a goal of predicting human movement in an accurate and cost-efficient manner. Because human movement simulation may be a relatively complex and costly process, some embodiments of the present invention provide a computerized method and system that captures the complex choreography of human motion to realistically simulate human motion. This computerized method may be adapted to any posture in a consistent manner without having to utilize such things as mathematical optimization methods. In addition, although simulation of “human” movement is used throughout this detailed description, any reasonable kinematic skeletal configuration may be simulated, such as that of an animal, fish or other suitable living object. This computerized method is utilized by human movement simulator 104, which may be either an individual employee, a group of employees employed by human movement simulation entity 102, or an independent computer program that initiates the method.

FIG. 1B is a block diagram of computer 106 for use in simulating human movement according to one embodiment of the present invention. In the illustrated embodiment, computer 106 includes an input device 110, an output device 112, a processor 114, a memory 116 storing human movement simulation application 118, and a database 120.

Input device 110 is coupled to computer 106 for allowing human movement simulator 104 to utilize human movement simulation application 118. For example, human movement simulator 104 may utilize hum movement simulation application 118 through one or more user interfaces contained within human movement simulation application 118. This allows human movement simulator 104 to input, select, and/or manipulate various data and information. In one embodiment, input device 110 is a keyboard; however, input device 110 may take other forms, such as an independent computer program, a mouse, a stylus, a scanner, or any combination thereof.

Output device 112 is any suitable visual display unit, such as a liquid crystal display (“LCD”) or cathode ray tube (“CRT”) display, that allows human movement simulator 104 to “see” the human movement that he or she is trying to simulate. For example, referring back to FIG. 1A, an example simulation 122 may be seen on output device 112. In the illustrated embodiment, a human is stepping forward and placing a box on a shelf. Output device 112 may also be coupled to recording device 108 for the purpose of recording any desired information, such as a simulation or other suitable information. For example, a simulation may be recorded on a DVD, CD-ROM, or other suitable media. A simulation may also be sent to a file or utilized by another computer program.

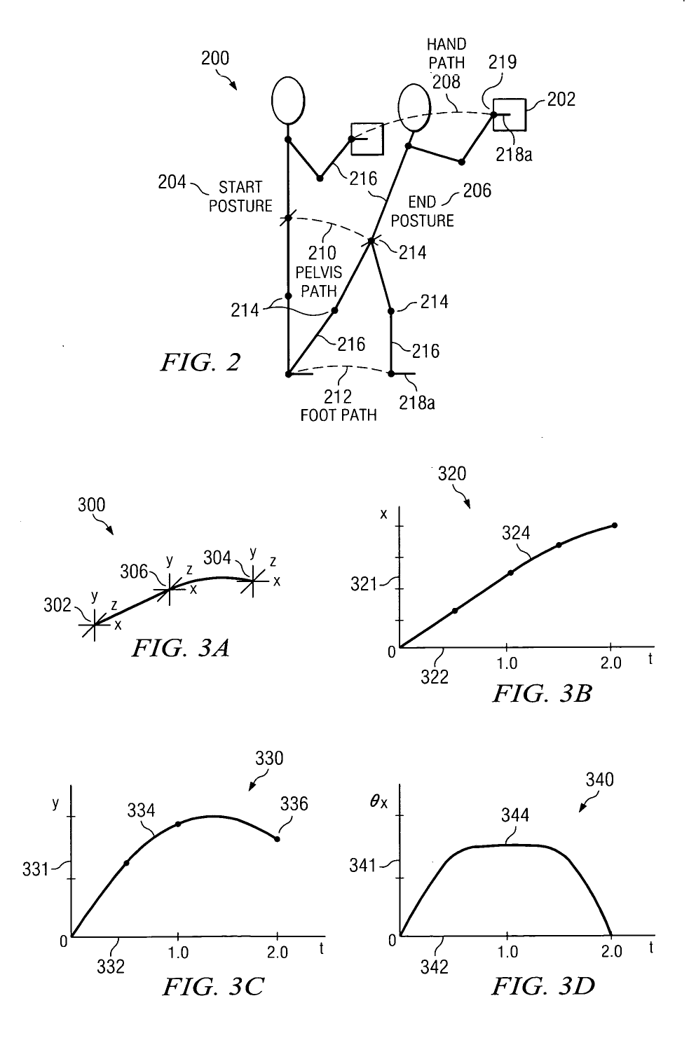

Processor 114 comprises any suitable type of processing unit that executes logic. One of the functions of processor 114 is to retrieve human movement simulation application 118 from memory 116 and execute human movement simulation application 118 to allow human movement simulator 104 to simulate human movement. Other functions of human movement simulation application 118 are discussed more fully below in conjunction with FIGS. 2 through 4. Processor 114 may also control the capturing and/or storing of information and other suitable data, such as data indicative of a measured movement of a human.

Human movement simulation application 118 is a computer program written in any suitable computer language. According to the teachings of the present invention, human movement simulation application 118 is operable to utilize data and information stored in database 120 and input by human movement simulator 104 for the purpose of simulating movement of a human. Human movement simulation application 118 may perform other suitable functions, capturing data indicative of a measured movement of a human. Some functions of human movement simulation application 118 are described below in conjunction with FIGS. 2 through 4. In the illustrated embodiment, human movement simulation application 118 is logic encoded in memory 116. However, in alternative embodiments, human movement simulation application 118 is implemented through application specific integrated circuits (“ASICs”), field programmable gate arrays (“FPGAs”), digital signal processors (“DSPs”), or other suitable specific or general purpose processors.

Memory 116 and database 120 may comprise files, stacks, databases, or other suitable organizations of volatile or nonvolatile memory. Memory 116 and database 120 may be random-access memory, read-only memory, CD-ROM, removable memory devices, or any other suitable devices that allow storage and/or retrieval of data. Memory 116 and database 120 are interchangeable and may perform the same functions. In the illustrated embodiment, database 120 stores various rules, formulas, tables, and other suitable logic that allows human movement simulation application 118 to perform its function when simulating human movement. Database 120 may also store data associated with the capturing of a measured movement of a human, such as that data captured with the use of motion capture technology.

FIGS. 2 through 3D illustrate the teachings of one embodiment of the present invention. The posture transition utilized to illustrate the teachings of this embodiment is a human simply stepping forward and placing a box on a shelf, as illustrated by an empirical model 200 in FIG. 2.

Referring to FIG. 2, empirical model 200 illustrates a human placing a box 202 on a shelf (not illustrated) according to one embodiment of the present invention. Empirical model 200 includes a plurality of joints 214 connected by a plurality of segments 216, and one or more end effectors 218. Empirical model 200 begins at a start posture 204 and ends at an end posture 206. During the transition of empirical model 200 from start posture 204 to end posture 206, each of the joints 214, segments 216, and end effectors 218 move along a particular profile path. For example, as illustrated in FIG. 2, a hand path 208 illustrates the profile path of an end effector 218a, which represents the hand of the human of empirical model 200, a pelvis path 210 represents the path taken by the pelvis joint of the human of empirical model 200, and a foot path 212 represents the path taken by an end effector 218b, which represents the foot of the human of empirical model 200. Although empirical model 200 and the various paths illustrated in FIG. 2 are represented in two-dimensional form, the present invention contemplates empirical model 200 being represented in three-dimensional form. The two-dimensional illustration is for simplicity purposes only.

During the transition of empirical model 200 from start posture 204 to end posture 206, position and orientation information for joints 214, segments 216 and end effectors 218 are captured using any suitable method, such as empirical data models, motion capture technology, and heuristic rules. The data representing the position and orientation information for each of the profile paths may be stored in any suitable location, such as database 120 (FIG. 1B). As described in greater detail below, these stored sets of data may be utilized to simulate the desired movement of a human performing a similar posture transition. Example data captured from empirical model 200 is illustrated in FIGS. 3B through 3D and is the type of data that may be stored in database 120 (FIG. 1B).

Referring now to FIG. 3A, an empirical profile path 300 illustrating the movement of end effector 218a (i.e., the hand of the human model in FIG. 2) is illustrated in accordance with one embodiment of the invention. Empirical path 300 includes an empirical start point 302 and an empirical end point 304. The position and orientation of end effector 218a at any time during the movement of end effector 218a from empirical start point 302 to empirical end point 304 is captured and stored as described above. The position and orientation information may be with respect to a fixed Cartesian coordinate system 306 or with respect to any suitable reference plane. For example, although not illustrated, another segment of a portion of the human's arm may be coupled to end effector 218a via a joint 219 and the angular position of end effector 218a may be with respect to the plane that that particular segment lies in.

Since empirical path 300 contains position, orientation, and timing data, the use of empirical profile paths to simulate human movement may be powerful for accomplishing otherwise difficult simulation tasks, such as keeping a model's hand (or hands) on a part or tool throughout a complex operation.

Example position and orientation data of end effector 218a from empirical start point 302 to empirical end point 304 is illustrated in FIGS. 3B through 3D. FIG. 3B is a graph 320 illustrating the horizontal position of end effector 218a with respect to time, FIG. 3C is a graph 330 illustrating the vertical position of end effector 218a with respect to time, and FIG. 3D is a graph 340 illustrating the orientation with respect to horizontal of end effector 218a with respect to time according to one embodiment of the invention. Although only two-dimensional data is illustrated in FIGS. 3B through 3D, three-dimensional data is contemplated by the present invention, as noted above. Accordingly, any particular joint 214, segment 216, and/or end effector 218 may be defined by up to six degrees of freedom (x, y, z, θₓ, θ_{y} and θ_{z}).

Referring to FIG. 3B, a y-axis 321 represents the horizontal position of end effector 218a and a y-axis 322 represents time. A curve 324 represents the horizontal position of end effector 218a during the time period of movement from empirical start point 302 to empirical end point 304. In the illustrated embodiment, the horizontal position of end effector 218a rises fairly steadily for the first 1.5 seconds until tapering off towards the end of the transition.

Referring to FIG. 3C, a y-axis 331 represents the vertical position of end effector 218a and an x-axis 332 represents time. A curve 334 represents the vertical position of end effector 218a during the time period of movement from empirical start point 302 to empirical end point 304. In the illustrated embodiment, the vertical position of end effector 218a rises fairly rapidly until reaching its maximum vertical position approximately 1.25 seconds through the time period. The vertical position then tapers off gradually until reaching its final vertical position, as denoted by reference numeral 336.

Referring to FIG. 3D, a y-axis 341 represents the angle with respect to the x-axis of end effector 218a and an x-axis 342 represents time. A curve 344 represents the angle of end effector 218a with respect to the x-axis during the time period of movement from empirical start point 302 to empirical end point 304. In the illustrated embodiment, the angle rises fairly rapidly during the first approximately 0.5 second of the time period, levels off for the next approximately one second of the time period, and then rapidly decreases back to zero degrees during the last 0.5 second of the time period.

Thus, capturing and storing the position and orientation data as illustrated in FIGS. 3B through 3D for end effector 218a of empirical model 200 (FIG. 2) facilitates, in one embodiment of the invention, the simulation of a desired movement of an actual hand of a human performing a similar movement (i.e., placing a box on a shelf) in a realistic and cost-efficient manner. In one embodiment, the relative change in position and orientation of end effector 218a between adjacent empirical end points may be applied to a plurality of points between the actual start point and the actual end point of the desired human movement to accurately simulate the movement.

In order to select the data representing a movement similar to the desired human movement, human movement simulator 104 (FIG. 1A) may select the appropriate empirical model, such as empirical model 200, using output device 112, or human movement simulation application 118 may perform this step automatically by any suitable comparison algorithm. Once an empirical model is selected that is representative of the desired movement, then the data related to that empirical model, such as empirical model 200, may be utilized to simulate the desired movement.

In an embodiment where the data in FIGS. 3B through 3D is utilized to simulate human movement, the data may be utilized in the following manner. It is known from this data the relative change in position and orientation of end effector 218a between adjacent empirical end points from empirical start point 302 to empirical end point 304. This relative change may then be applied to a plurality of points between an actual start point and an actual end point of a desired human movement to accurately predict the profile path of this end effector.

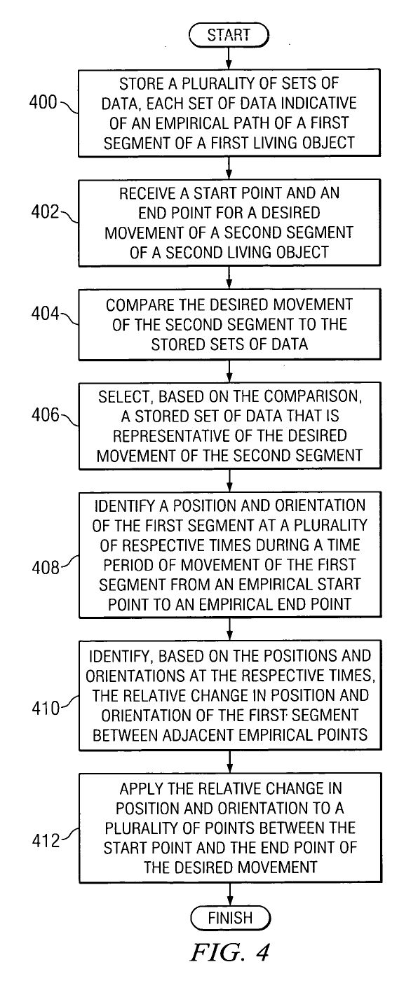

FIG. 4 is a flowchart illustrating an example computerized method of simulating human movement according to one embodiment of the invention. The example method begins at step 400 where a plurality of sets of data are stored in database 120 (FIG. 1B). Each set of data is indicative of an empirical path, such as empirical path 300 (FIG. 3A), of a first segment of a first living object. For example, the first segment may be end effector 218a, which represents a hand of a human. A start point and an end point for a desired movement of a hand of a second living object is received, as denoted by step 402. For purposes of this example, the desired movement is a person placing a box on a shelf. This desired movement is compared to the stored sets of data at step 404. A stored set of data that is representative of the desired movement of the hand is selected at step 406 so that the movement of a hand placing a box on a shelf may be simulated with accuracy.

In order to simulate this movement, a position and orientation of the first segment, such as end effector 218a, is identified at step 408 for a plurality of respective times during a time period of movement of end effector 218a from empirical start point 302 to empirical end point 304. Based on these positions and orientations at the respective times, the relative change in position and orientation between adjacent empirical points is identified at step 410. The relative change in position and orientation is applied to a plurality of points between the start point and the end point of the desired movement of the hand at step 412 in order to simulate the movement of a hand placing a box on a shelf. This ends the example method outlined in FIG. 4.

U.S. patent application Ser. No. 10/246,880, filed Sep. 18, 2002, which is herein incorporated by reference, discloses the novel use of joint angle profiles for adding realistic human movement choreography to posture transitions using joint angle interpolation. The teachings of some embodiments of the present invention may be combined with the teachings of some embodiments of application Ser. No. 10/246,880 to enhance the simulation of human movement. For example, the transition of the spinal vertebrae and shoulders may be governed by the angle-based profile interpolation described in application Ser. No. 10/246,880, while the hands and feet transition via the profile paths described herein. The entire solution is independent of the specific kinematic definition of the human figure, providing a solution that may be used with any human model definition.

Although embodiments of the invention and their advantages are described in detail, a person skilled in the art could make various alterations, additions, and omissions without departing from the spirit and scope of the present invention as defined by the appended claims.

1. A computerized method for simulating movement of a living object, comprising:
storing a plurality of sets of data, each set of data indicative of an empirical path of a first segment of a first living object;
receiving a start point and an end point for a desired movement of a second segment of a second living object;
comparing the desired movement of the second segment to the stored sets of data;
selecting, based on the comparison, a stored set of data that is representative of the desired movement of the second segment; and
simulating the desired movement of the second segment based on the start point, the end point, and the empirical path associated with the selected set of data.

2. The computerized method of claim 1, wherein the simulating step comprises:
identifying a position and an orientation of the first segment at a plurality of respective times during a time period of movement of the first segment from an empirical start point to an empirical end point;
identifying, based on the positions and orientations at the respective times, the relative change in position and orientation of the first segment between adjacent empirical points; and
applying the relative change in position and orientation to a plurality of points between the start point and the end point of the desired movement.

3. The computerized method of claim 2, further comprising dividing the time period into approximately equal times.

4. The computerized method of claim 2, wherein identifying the relative change in position comprises identifying a relative change in position of the first segment relative to a fixed Cartesian coordinate system as the first segment moves between adjacent empirical points.

5. The computerized method of claim 2, wherein identifying the relative change in orientation comprises identifying a relative change in angle of the first segment relative to a reference plane as the first segment moves between adjacent empirical points.

6. The computerized method of claim 5, further comprising associating the reference plane with a fixed Cartesian coordinate system.

7. The computerized method of claim 5, further comprising associating the reference plane with a plane that corresponds to an axis of an adjacent segment.

8. The computerized method of claim 1, wherein the living object is a human.

9. Logic encoded in media for simulating movement of a living object, the logic operable to perform the following steps:
store a plurality of sets of data, each set of data indicative of an empirical path of a first segment of a first living object;
receive a start point and an end point for a desired movement of a second segment of a second living object;
compare the desired movement of the second segment to the stored sets of data;
select, based on the comparison, a stored set of data that is representative of the desired movement of the second segment; and
simulate the desired movement of the second segment based on the start point, the end point, and the empirical path associated with the selected set of data.

10. The logic encoded in media of claim 9, wherein the logic is further operable to:
identify a position and an orientation of the first segment at a plurality of respective times during a time period of movement of the first segment from an empirical start point to an empirical end point;
identify, based on the positions and orientations at the respective times, the relative change in position and orientation of the first segment between adjacent empirical points; and
apply the relative change in position and orientation to a plurality of points between the start point and the end point of the desired movement.

11. The logic encoded in media of claim 9, wherein the logic is further operable to divide the time period into approximately equal times.

12. The logic encoded in media of claim 10, wherein the logic, is further operable to identify a relative change in position of the first segment relative to a fixed Cartesian coordinate system as the first segment moves between adjacent empirical points.

13. The logic encoded in media of claim 10, wherein the logic is further operable to identifying a relative change in angle of the first segment relative to a reference plane as the first segment moves between adjacent empirical points.

14. The logic encoded in media of claim 13, wherein the logic is further operable to associate the reference plane with a fixed Cartesian coordinate system.

15. The logic encoded in media of claim 13, wherein the logic is further operable to associate the reference plane with a plane that corresponds to an axis of an adjacent segment.

16. The logic encoded in media of claim 9, wherein the living object is a human.

17. A computerized method for simulating movement of a living object, comprising:
storing a plurality of sets of data, each set of data indicative of an empirical path of a first segment of a first living object;
receiving a start point and an end point for a desired movement of a second segment of a second living object;
comparing the desired movement of the second segment to the stored sets of data;
selecting, based on the comparison, a stored set of data that is representative of the desired movement of the second segment; and
identifying a position of the first segment at a plurality of respective times during a time period of movement of the first segment from an empirical start point to an empirical end point;
identifying, based on the positions at the respective times, the relative change in position of the first segment between adjacent empirical points; and
applying the relative change in position to a plurality of points between the start point and the end point of the desired movement.

18. The computerized method of claim 17, further comprising:
identifying an orientation of the first segment at the plurality of respective times;
identifying, based on the orientations at the respective times, the relative change in orientation of the second segment between adjacent empirical points; and
applying the relative change in orientation to the plurality of points between the start point and the end point of the desired movement.

19. The computerized method of claim 17, further comprising dividing the time period into approximately equal times.

20. The computerized method of claim 17, wherein identifying the relative change in position comprises identifying a relative change in position of the first segment relative to a fixed Cartesian coordinate system as the first segment moves between adjacent empirical points.

21. The computerized method of claim 18, wherein identifying the relative change in orientation comprises identifying a relative change in angle of the first segment relative to a reference plane as the first segment moves between adjacent empirical points.

22. The computerized method of claim 21, further comprising associating the reference plane with a fixed Cartesian coordinate system.

23. The computerized method of claim 21, further comprising associating the reference plane with a plane that corresponds to an axis of an adjacent segment.

24. The computerized method of claim 17, wherein the living object is a human.
